(19) United States
(12) Patent Application Publication
(10) Pub. No.: US 2010/0294237 A1
(43) Pub. Date: Nov. 25, 2010

(54) Air swirling device for fuel injected internal combustion engines

(75) Inventor: Daniel Allen Keegan, East Alton, IL (US)

Correspondence Address: Daniel A. Keegan, 326 Tower Drive, East Alton, IL, 62024, US

(73) Assignee: Daniel Allen Keegan, East Alton, IL (US)

(21) Appl. No.: 12/454,846

(22) Filed: May 22, 2009

(51) Int. Cl. F02B 31/00

(52) U.S. Cl. 123/306

(57) ABSTRACT

One embodiment of a device utilized to provide swirling intake air flow of a fuel injected internal combustion engine which is inserted into an air intake tube 22 (FIG. 9) or secured to the throttle body air inlet. The device is formed from a single piece of semi-rigid material and includes a plurality of integrated air swirling vanes 16. The body 10 (FIG. 5) can be formed to the shape of the air intake tube, generally circular or elliptical, with a longitudinal seam for adjusting fitment. The plurality of vanes 16 (FIG. 7) are angled 18 (FIG. 7) to create a swirling motion of the incoming air that is moving towards the butterfly valve FIGS. 1A, 1B, 2A, 2B, 3A, 3B, 4A and 4B of the throttle body. The swirling motion of air generated by the plurality of vanes 16 provides a more complete mixing of the air and fuel within the combustion chamber of the fuel injected internal combustion engine, thus providing a more complete combustion of the air-fuel mixture.

### CROSS-REFERENCE TO RELATED APPLICATIONS

Non-applicable.

### FEDERALLY SPONSORED RESEARCH

Non-applicable.

### SEQUENCE LISTING OR PROGRAM

Non-applicable.

### BACKGROUND OF THE INVENTION

1. Field

This invention generally relates to an air swirling device, specifically to an improved air swirling device for fuel injected internal combustion engines and more particularly, to an air swirling device for improved air and fuel mixing within the combustion chamber of an internal combustion engine which improves engine efficiency. Improved engine efficiency results in improved fuel efficiency and reduced emissions.

2. Prior Art

A problem exists in the efficiency of the internal combustion engine, even though the manufacturers make minor improvements each passing year. It is known that a swirling motion or turbulent air flow within the combustion chamber of an internal combustion engine assists in the vaporization or atomization of fuel, therefore creating an improved air-fuel mixture. An improved air-fuel mixture results in added horsepower, lower emissions and increased fuel efficiency. A problem exists in the operating range of air swirling devices. The operating range of an internal combustion engine is from idle, low revolutions per minute, to wide open throttle, high revolutions per minute.

Devices such as the turbo charger or super charger, also referred to as a blower, which force additional air into the combustion chamber of internal combustion engines to produce increased horsepower. These devices are expensive and require a high technical ability to install. Though the devices increase horsepower, they generally have little effect on emissions or fuel efficiency. It is commonly found that these devices are installed in smaller displacement internal combustion engines of lower emissions and higher fuel efficiency to equal a larger displacement counterpart without such a device. Many attempts at creating a simple, easy to use, easy to install, and inexpensive air swirling device in prior art have been made. These prior attempts were able to generate some swirling motion when introduced into automotive engines, though lacked simplicity and attention to the butterfly valve. Butterfly valves exist in both carbureted and fuel injected engines. Examples of this can be seen in prior art as disclosed in U.S. Pat. No. 6,536,420 to Chen, Mar. 25, 2003 U.S. Pat. No. 4,962,642 to Kim, Oct. 16, 1990 and U.S. Pat. Application Publication in Pub. No. US2003/0226539 Al to Kim, Dec. 11, 2003. The complexity of prior art suggests higher manufacturing costs and higher technical skills for installation.

A simplified description of air flow and the point in which fuel is introduced in fuel injected internal combustion engines is as follows. Air is drawn through the air filtration system which removes contaminates continues to travel in a linear flow through the air intake tube towards the throttle body mechanism. The throttle body mechanism contains a butterfly valve which controls the amount of air that is to continue through the air intake manifold, past the intake valve and into the combustion chamber. As the air nears the combustion chamber a fuel injector, located in the air intake manifold or cylinder head, introduces a specific amount of fuel. A key component in the air flow process for fuel injected internal combustion engines that make some prior art less effective is the throttle body butterfly valve.

FIG. 1A and FIG. 1B represent a closed throttle body butterfly valve. This is to show the butterfly valve position while an engine is not operating or closed position. FIG. 2A and FIG. 2B represent a throttle body butterfly valve in idle position while the engine is in operation. Typical engine operation at idle, low revolutions per minute, suggest that the butterfly valve position ranges from approximately 8% to 15% open which, as shown by 2, allows very little air to pass around the edges of the butterfly valve. FIG. 3A and FIG. 3B represent a throttle body butterfly valve in highway speed position while the engine is in operation. Typical engine operation at highway speeds, mid-range revolutions per minute, suggest that the butterfly valve position ranges from approximately 17% to 35% open which, as shown by 4, allows more air to pass around the edges of the butterfly valve. FIG. 4A and FIG. 4B represent a throttle body butterfly valve at the wide open throttle position while the engine is in operation. Typical engine operation at wide open throttle, high revolutions per minute, suggest that the butterfly valve position ranges from approximately 60% to 100% open which, as shown by 6, allows the full flow of air to pass through the butterfly valve.

### SUMMARY

In accordance with one embodiment an air swirling device for fuel injected internal combustion engines comprising of a thin horizontal body having a plurality of acute angled vanes vertical to said body. The body can be formed to fit within an air intake tube or throttle body air inlet to improve engine efficiency.

### DRAWINGS—FIGURES

In the drawings, closely related figures have the same number but different alphabetic suffixes.

FIG. 1A shows a sectional side view of a butterfly valve within a throttle body in closed position.

FIG. 1B shows a front view of a butterfly valve within a throttle body in closed position.

FIG. 2A shows a sectional side view of a butterfly valve within a throttle body in idle position.

FIG. 2B shows a front view of a butterfly valve within a throttle body in idle position.

FIG. 3A shows a sectional side view of a butterfly valve within a throttle body in highway speed position.

FIG. 3B shows a front view of a butterfly valve within a throttle body in highway speed position.

FIG. 4A shows a sectional side view of a butterfly valve within a throttle body in wide open throttle position.

FIG. 4B shows a front view of a butterfly valve within a throttle body in wide open throttle position.

FIG. 5 shows the top view of body of device.

FIG. 6 shows an enlarged partial top view of body of device.

FIG. 7 shows an enlarged partial top view of body of device with vane details.

FIG. 8 shows an enlarged sectional view of vane—sectional view A-A.

FIG. 9 shows a cut-away side view of a typical air intake system to throttle body.

FIG. 10A shows an end view of circular formed body of device.

FIG. 10B shows an end view of elliptical formed body of device.

FIG. 11 shows an isometric cut-away side view of air intake tube.

FIG. 12 shows an end view of formed body of device joined at ends.

FIG. 13 shows an end view of formed body of device with overlapping ends.

FIG. 14A shows an enlarged partial top view of body of device with alternate vane height tabs—version A.

FIG. 14B shows an enlarged partial top view of body of device with alternate vane height tabs—version B.

FIG. 14C shows an enlarged partial top view of body of device with alternate vane height tabs—version C.

FIG. 15 shows an enlarged partial top view of body of device with alternate vane direction details.

FIG. 16 shows the top view of body of device with placement holding tabs.

FIG. 17 shows an isometric top view of unformed body of device.

FIG. 18 shows an isometric end view of formed body of device.

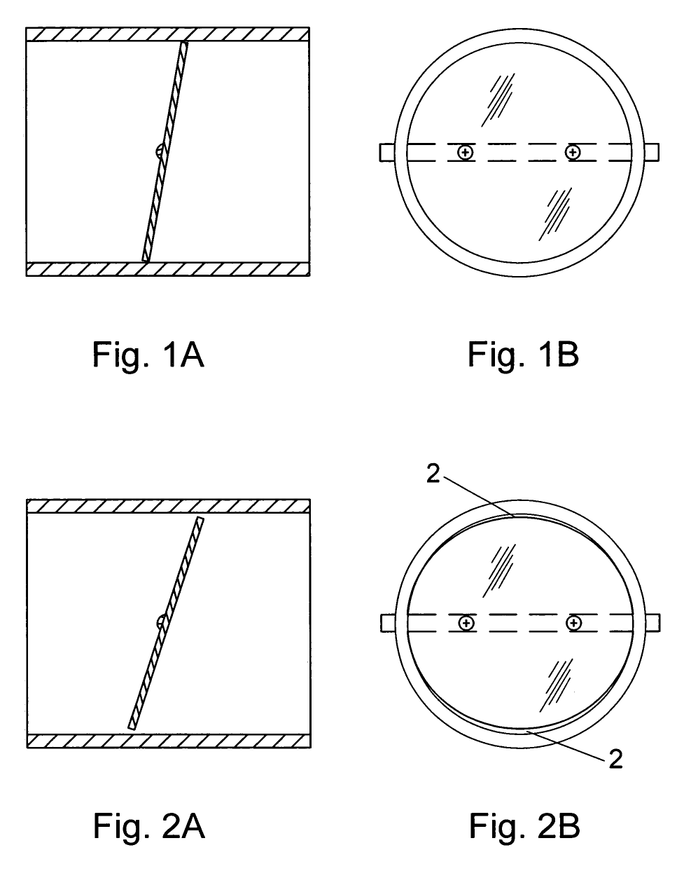

### DRAWINGS—REFERENCE NUMERALS

In the drawings, closely related reference numbers have the same number but different alphabetic suffixes.

| | | | |
|---|---|---|---|
| 2 | open area in idle position | 4 | open area in highway |
| | | | speed position |
| 6 | open area in wide open | 10 | body of device |
| | throttle position | | |
| 12 | cut | 14 | vane tab |
| 14b | alternate vane tab “b” - | 14c | alternate vane tab “c” - |
| | height of vane | | height of vane |
| 14d | alternate vane tab “d” - | 14e | alternate vane tab “e” - |
| | height of vane | | height of vane |
| 16 | vane | 16a | alternate vane direction |
| 18 | acute angle to the left | 18a | acute angle to the right |
| 20 | throttle body | 22 | air intake tube |
| 24 | air filtration unit | 26 | placement holding tab |

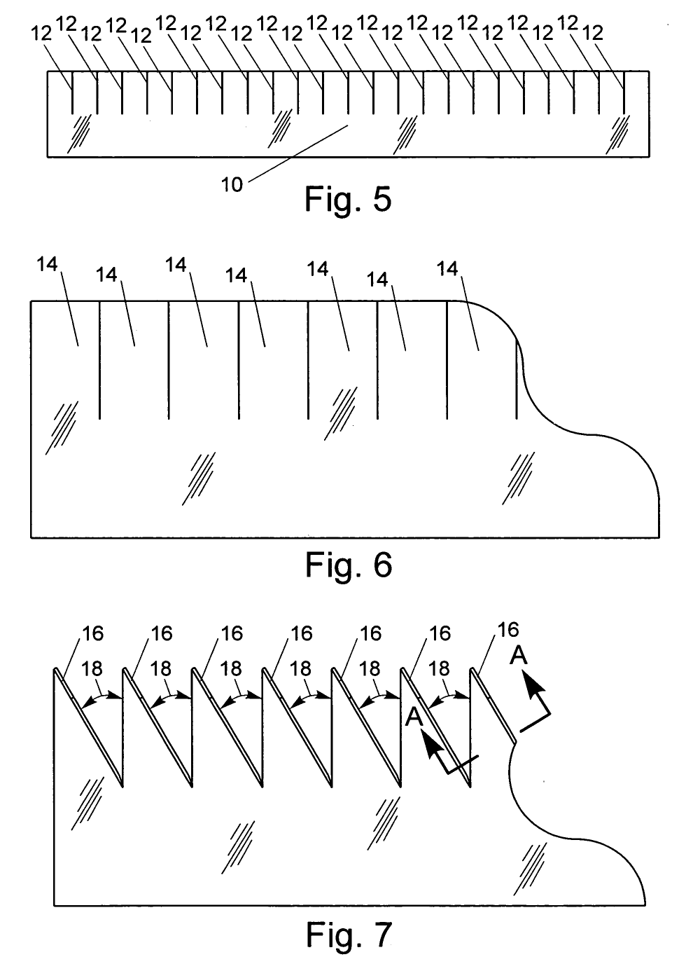

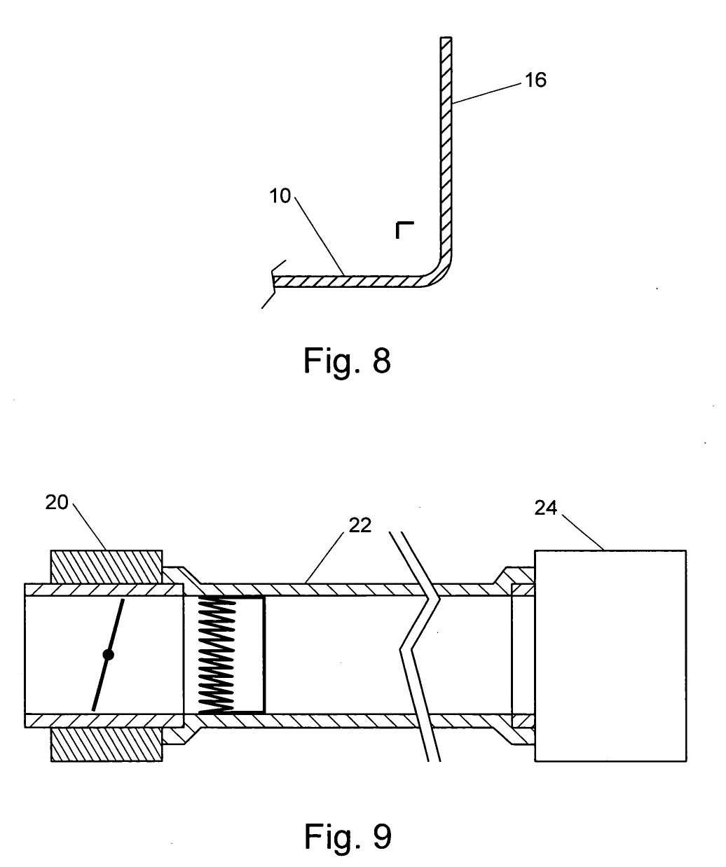

### DETAILED DESCRIPTION—FIRST EMBODIMENT—FIGS. 5, 6, 7 and 8

One embodiment of the device as illustrated in FIGS. 5, 6, 7 and 8. The device has a thin rectangular body 10 (FIG. 5) consisting of a semi-rigid material which can be bent and shaped. In the preferred embodiment, the body is a semi-rigid metal, such as a 26 gauge 304 stainless steel available from a wide variety of suppliers. However, the body can consist of any other semi-rigid smooth surfaced material that can be formed and withstand high heat, extreme cold, moisture and oil resistance while providing longevity, such as various grades of stainless steel, nickel plated steel, steel and aluminum alloys, nylon, plastic and plastic composites, rubber and rubber composites, etc. Thickness can also vary so long as not to restrict air flow and remain pliable enough to shape.

Along top longitudinal side of the body 10 a plurality of equidistant cuts 12 (FIG. 5) perpendicular to the longitudinal side are made at a distance equal to one half of the width of the body 10 to form the vane tabs 14 (FIG. 6). In the preferred embodiment, the longitudinal side of the body 10 would be 10.32 inches and the body 10 width at 1.50 inches. Therefore, 23 equidistant perpendicular cuts 12 spaced 0.43 inches apart and 0.75 inches in length, which forms 24 vane tabs 14, would be made which would accommodate air intake tubes or throttle body air intakes of vehicles with engine sizes from 1.8 liters to 6.1 liters or larger. However, the cuts 12 and body 10 sizes can vary depending upon application, such as motorcycles or all terrain vehicles (ATVs), etc., that would require a smaller body 10.

Each vane tab 14 shall form a vane 16 (FIG. 7) at a right angle to the horizontal plane of the body 10. The vertical plane of the vane 16 shall have an acute angle 18 (FIG. 7) of approximately 30 degrees. Whereas, the arm of said angle 18 being the cut 12 and the vertex of said angle being the end of the cut 12 with an angle 18 to the left of approximately 30 degrees in which the vertical plane of the vane 16 is the second arm of said angle. In the preferred embodiment, the angle 18 of the vane 16 is approximately 30 degrees. However, the angle 18 can range from 15 degrees to 35 degrees. A lesser angle 18 may not generate an adequate swirling motion, where an angle 18 greater than 35 degrees may create a restriction in the air flow.

### OPERATION—FIRST EMBODIMENT—FIGS. 2A, 2B, 3A, 3B, 4A, 4B, 5, 7, 8, 9, 10A, 10B, 11, 12 and 13

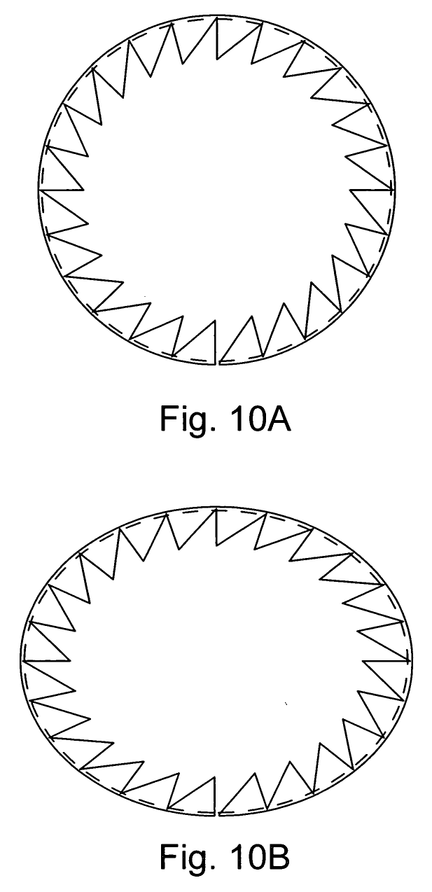

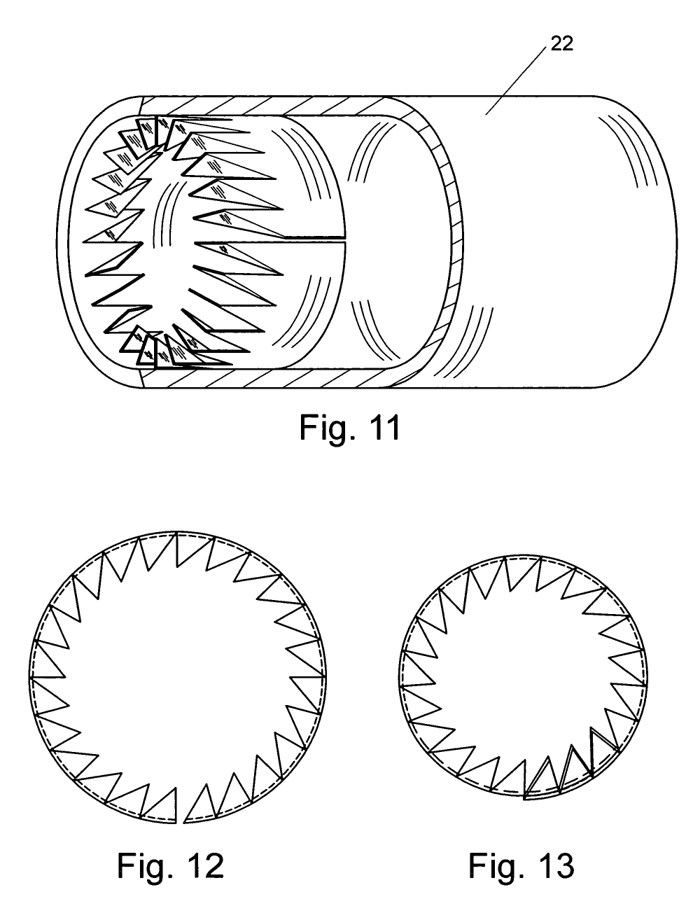

The manner of using this air swirling device is by installing into the air intake tube of a fuel injected internal combustion engine. Namely, one first separates the air intake tube 22 (FIG. 9) from the throttle body 20 (FIG. 9). Next, insert the air swirling device with the vanes 16 (FIG. 7) pointing towards the throttle body 20 into the air intake tube 22 as close to the throttle body 20 as possible. The air swirling device shall be formed to the inside wall (FIGS. 10A, 10B and 11) of the air intake tube 22 so that it is flush with aforementioned wall with the ends of the body 10 joining, as shown in FIG. 12, or by the ends of the body 10 overlapping, as shown in FIG. 13. However, in the case of an overlapping of the ends of the body 10, one can remove the overlapping portion to form a new end. Then one returns the air intake tube 22 to original connected position with throttle body 20.

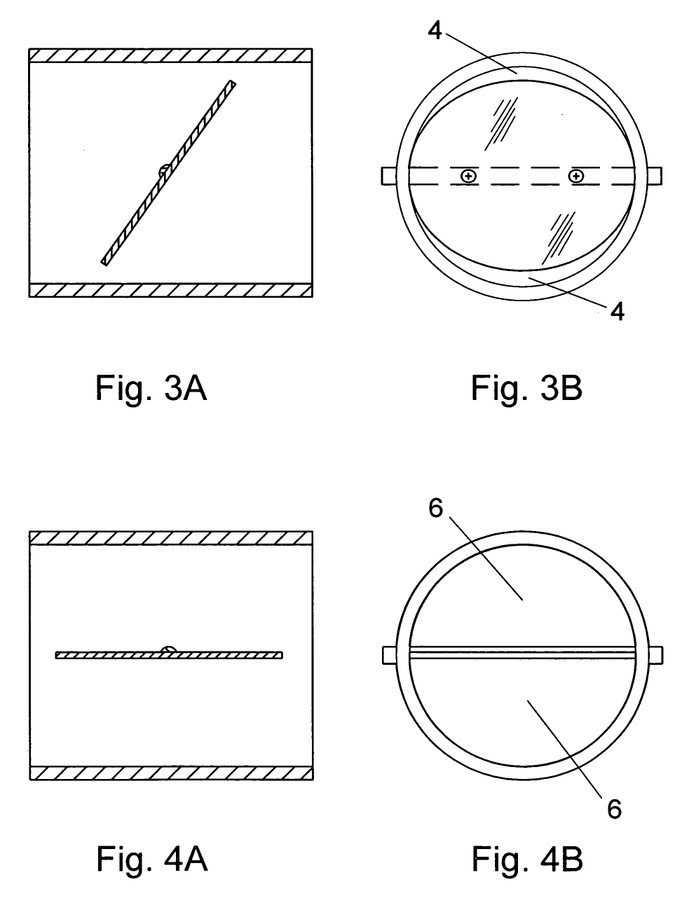

As shown in FIGS. 2A, 2B, 3A, 3B, 4A, 4B, 7, 8, 9 and 11 of the present air swirling device, when air passes through the air swirling device, that air is directed towards the walls of the air intake tube 22 and throttle body 20 in a clockwise rotational motion, as suggested in FIG. 7, in the direction of the butterfly valve (FIGS. 2A, 2B, 3A, 3B, 4A, 4B and 9). Some air that would normally have been restricted by the butterfly valve (FIGS. 2A, 2B, 3A and 3B) is now allowed to flow past the open area (FIGS. 2A, 2B, 3A, 3B, 4A and 4B) between the butterfly valve and throttle body air passage while maintaining a clockwise rotational motion. Air that has passed the butterfly valve (FIGS. 2A, 2B, 3A, 3B, 4A and 4B) continues to travel in a clockwise rotational motion along the walls of the throttle body air passage exit and into the air intake manifold towards the combustion chamber of a fuel injected internal combustion engine. Also, as the swirling air that is traveling along the walls and into the air intake manifold will cause the center core of air, that would normally travel in a linear motion, to join in a clockwise rotational motion. Then the swirling air passes through the air intake manifold to a point at which the fuel is introduced by the fuel injector and before the combustion chamber. It is at this point in which the swirling air mixes with the fuel causing the fuel to vaporize or atomize while traveling towards and into the combustion chamber. The swirling air-fuel mixture that enters the combustion chamber causes a more complete combustion, thus, improving the efficiency of the fuel injected internal combustion engine.

### DESCRIPTION—ALTERNATIVE EMBODIMENT—FIGS. 5, 6, 7, 9, 14A, 14B, 14C, 15 and 16

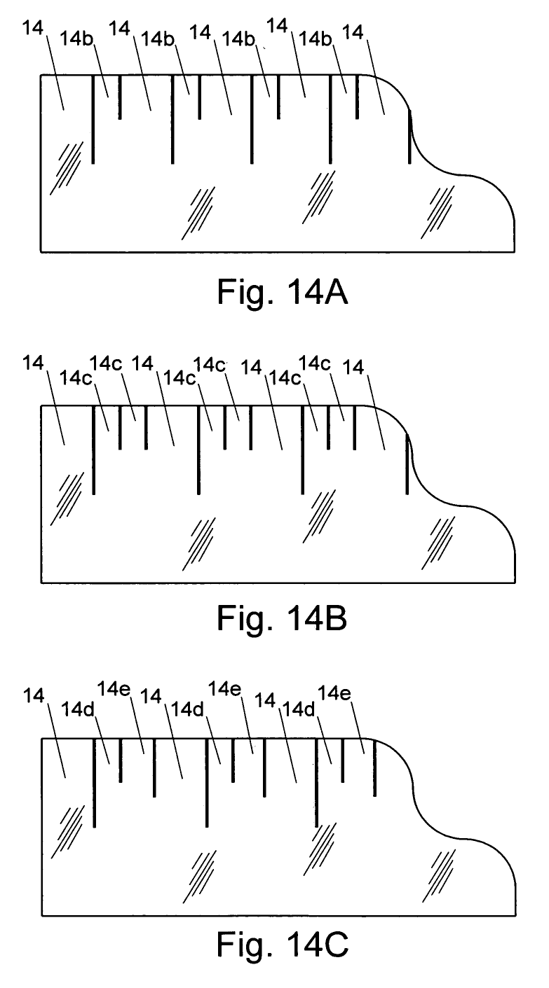

There are various possibilities with regard to the disposition of the vanes 16 (FIG. 7). It is possible to alternate the height of the vanes 16 by alternating the width of the vane tabs 14, 14b, 14c, 14d, 14e or a multitude of combinations as shown in FIGS. 14A, 14B and 14C.

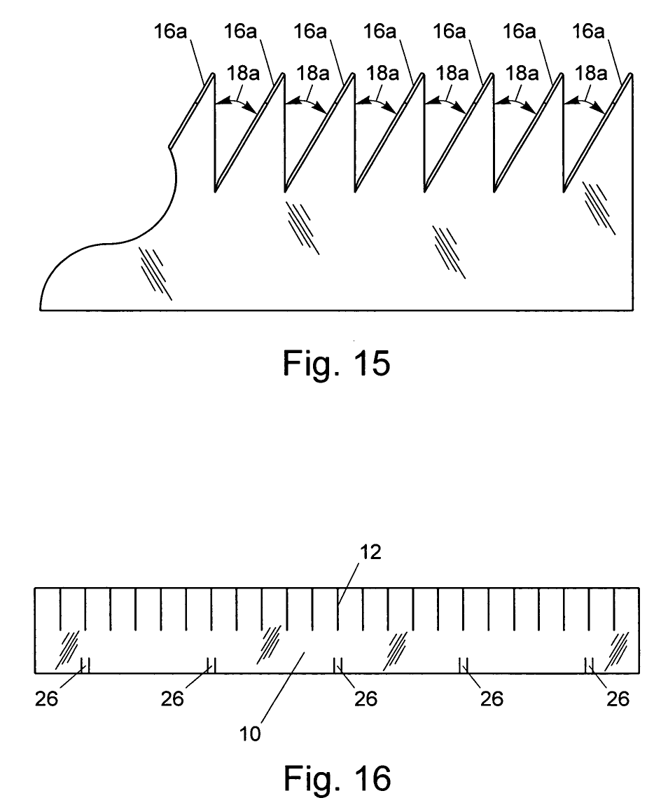

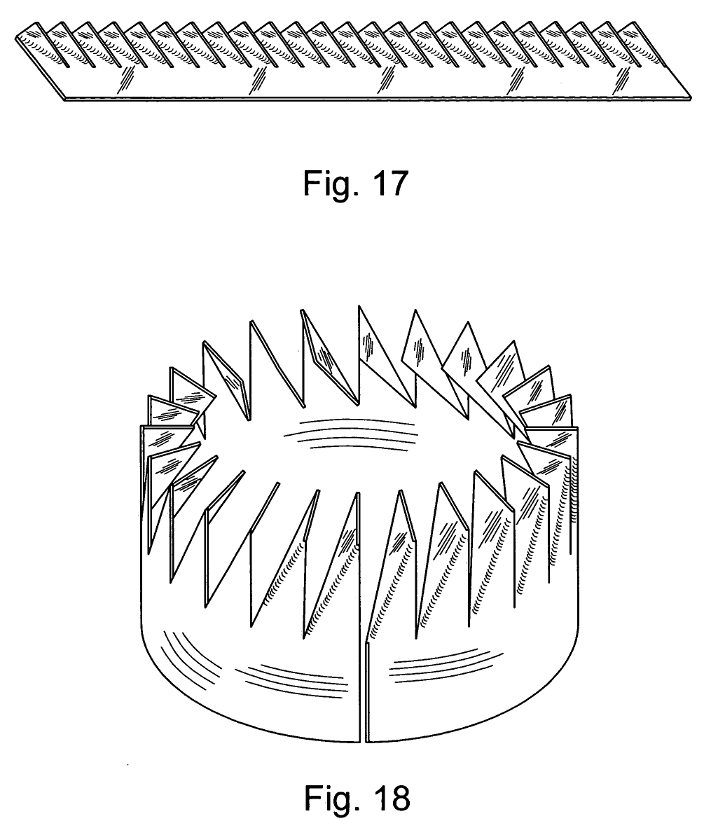

The swirling of air in a clockwise motion can be modified to flow in a counter-clockwise motion as shown in FIG. 15. Each vane tab 14 (FIG. 6) shall form a vane 16a (FIG. 15) at a right angle to the horizontal plane of the body 10 (FIG. 5). The vertical plane of the vane 16a shall have an acute angle 18a (FIG. 15) of approximately 30 degrees. Whereas, the arm of said angle 18a being the cut 12 (FIG. 5) and the vertex of said angle being the end of the cut 12 with an angle 18a (FIG. 15) to the right of approximately 30 degrees in which the vertical plane of the vane 16a is the second arm of said angle. In the preferred embodiment, the angle 18a of the vane 16a is approximately 30 degrees. However, the angle 18a can range from 15 degrees to 35 degrees. A lesser angle 18 may not generate an adequate swirling motion, where an angle 18a greater than 35 degrees may create a restriction in the air flow.

Another alternative would be to add a plurality of placement holding tabs 26 (FIG. 16). These placement holding tabs 26 can be bent or formed to stop movement of the air swirling device in the air intake tube 22 (FIG. 9) or if placed within the air inlet of the throttle body 20 (FIG. 9). By bending or forming the placement holding tabs 26 around the flange edge of the throttle body 20 air inlet will stop the air swirling device from moving towards the butterfly valve and causing interference with its operation.

When space is limited in either the air intake tube 22 or air inlet of the throttle body 20, it is possible to remove a portion of the lower bottom of the body 10, the area between the end of cuts 12 and bottom of body 10. The amount removed shall not interfere with the functionality of the air swirling device. This can also be performed during the construction process by reducing the width of the body 10, but maintaining cut 12 lengths as if the full width were used.

Advantages

From the description above, a number of advantages of some embodiments of my air swirling device become evident:
(a) Provides simple construction that could be performed by common hand tools.
(b) Provides a full operational range in fuel injected internal combustion engines.
(c) Improves engine efficiency.
(d) Easy installation without the expense of engine disassembly and assembly.
(e) Flexibility in construction and use.
(f) A more efficient engine reduces the frequency of engine oil changes.
(g) A more efficient engine improves fuel economy and reduces emissions.

### CONCLUSION, RAMIFICATIONS, AND SCOPE

Accordingly the reader will see that the air swirling device, according to one embodiment of the invention, I have provided can be used to improve the efficiency of fuel injected internal combustion engines, can easily be constructed, installed and modified, if needed. Because of its simplicity, manufacturing costs should be minimized. Also, the full operational range, from idle to wide open throttle, may have a distinct advantage over prior art by utilizing more engine efficiency at the lower to mid revolutions per minute range.

Many other ramifications and variations are possible within the teachings of the various embodiments. For example, an air swirling device constructed from the preferred material has the potential to last longer than the life of the engine. Another example would be a smaller scale version to benefit motorcycles, all terrain vehicles (ATVs), portable power generators, lawn tractors, water crafts, etc.

While the above description contains many specificities, these should not be construed as limitations on the scope of any embodiment, but as exemplifications of the presently preferred embodiments thereof. For example, the height of the vanes can alternate; the acute angle of the vanes can vary from 15 degrees to 35 degrees; the shape can be other than circular or elliptical; the body can have placement holding tabs; the overall size can vary to accommodate either larger or smaller air intake systems.

Thus the scope of the invention should be determined by the appended claims and their legal equivalents, and not by the examples given.

I claim:

1. An air swirling device for fuel injected internal combustion engines, comprising:
a. a rectangular body of thin semi-rigid material,
b. said body having a plurality of acute angled vertical vanes formed from one longitudinal side,
c. said body to be formed to the interior wall of either air intake tube or throttle body air inlet,
d. whereby causing air passing through the device to swirl.

2. An air swirling device with placement holding tabs for fuel injected internal combustion engines, comprising:
a. a rectangular body of thin semi-rigid material,
b. said body having a plurality of acute angled vertical vanes formed from one longitudinal side,
c. said body having a plurality of formable perpendicular placement holding tabs to opposite longitudinal side,
d. said body to be formed to the interior wall of either air intake tube or throttle body air inlet and secured by said placement holding tabs,
e. whereby causing air passing through the device to swirl.
